(19) United States
(12) Patent Application Publication
(10) Pub. No.: US 2012/0030122 A1
(43) Pub. Date: Feb. 2, 2012

(54) AGILE WORKFLOW MODELING AND EXECUTION BASED ON DOCUMENT

(75) Inventors: Mohammad Ashiqur Rahaman, Nice (FR); Andreas Schaad, Karlsruhe (DE); Yves Roudier, Saint Laurent du Var (FR)

(73) Assignee: SAP AG, Walldorf (DE)

(21) Appl. No.: 12/844,508

(22) Filed: Jul. 27, 2010

(51) Int. Cl. G06Q 10/00

(52) U.S. Cl. 705/301

(57) ABSTRACT

A workflow document processing machine supports agile modeling and agile execution of a workflow that comprises tasks, one or more of which may be dynamically added, changed, or identified during execution of the workflow. The workflow document processing machine accesses a pre-process workflow document, a tactical goal data structure, and business process data resultant from execution of a task pertinent to the workflow. The workflow document processing machine modifies a document portion based on the task data structure and on the business process data. Based on the pre-process workflow document and on the modified document portion, the workflow document processing machine generates a post-process workflow document, which may be accessed as a pre-process workflow document by another machine.

### TECHNICAL FIELD

The subject matter disclosed herein generally relates to the processing of data. Specifically, the present disclosure addresses systems and methods of workflow modeling based on a document and workflow execution based on a document.

### BACKGROUND

In management of an organization (e.g., a business), work may be performed by one or more subdivisions of the organization (e.g., departments or workgroups). Generally, the work is directed toward achievement of a goal, and contributions of various subdivisions toward the goal may be viewed as a “workflow” among the contributing subdivisions.

A machine (e.g. a computer) may be utilized to facilitate management of the workflow. For example, a machine may model a workflow as a checklist of uncompleted tasks to be individually marked as “done” when the tasks are completed. A workflow that describes a set of predefined tasks to be executed in a predefined order may be considered a task-based workflow.

### BRIEF DESCRIPTION OF THE DRAWINGS

Some embodiments are illustrated by way of example and not limitation in the figures of the accompanying drawings in which:

FIG. 1 is a network diagram illustrating a system that includes multiple machines, according to some example embodiments;

FIG. 2 is a diagram illustrating a trigger event and corresponding business goals, according to some example embodiments;

FIG. 3 is a block diagram illustrating tactical goals included in a business goal, according to some example embodiments;

FIG. 4 is a diagram illustrating business processes that correspond to tactical goals, according to some example embodiments;

FIG. 5 is a diagram of a business process facilitating generation of a post-process workflow document based on a pre-process workflow document, according to some example embodiments;

FIG. 6 is a block diagram illustrating a database storing a business goal data structure with tactical goal data structures and task data structures, according to some example embodiments;

FIG. 7 is a block diagram of the database storing the pre-process workflow document and the post-process workflow document, according to some example embodiments;

FIG. 8 is a flowchart illustrating a method performed by three machines in support of a workflow, according to some example embodiments;

FIG. 9 is a block diagram illustrating components of a workflow document processing machine, according to some example embodiments;

FIG. 10-12 are flowcharts illustrating operations in a method of agile workflow modeling and execution based on a document, according to some example embodiments; and

FIG. 13 is a block diagram illustrating components of a machine, according to some example embodiments, able to read instructions from a machine-readable medium and perform any one or more of the methodologies discussed herein.

### DETAILED DESCRIPTION

Example methods and systems are directed to agile workflow modeling and execution based on a document. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Modeling or execution of a workflow may be deemed as “agile” where tasks that comprise the workflow and their sequence of execution are not predefined. An agile workflow allows dynamic changes to be made in a set of tasks (e.g., at runtime). While a task pertinent to the workflow may be predefined, an agile workflow may also support tasks that are defined during execution of the workflow by user input or tasks identified during execution of the workflow by a query of a database (e.g., based on a semantic annotation corresponding to the task).

Moreover, an agile workflow may be modeled or executed based on a document (e.g., an eXtensible Markup Language (XML) file). Such a document may be termed a “workflow document” and may be communicated among multiple machines that correspond to various tasks in the workflow. In some example embodiments, the workflow document is “stateless” with respect to the workflow in the sense that the workflow document does not correspond to any information (e.g., metadata) that indicates a status of the document with respect to the workflow. For example, the workflow document may be stored without any metadata that indicates the document as being partially complete (e.g., 50% complete). In a situation where tasks of a workflow may dynamically change (e.g., be added, deleted, or rearranged), a stateless document may be helpful in modeling for executing the workflow.

Various example embodiments are described herein as being pertinent to management of an electronic health record. While the example context of an electronic health record provides a convenient source of illustrative details that may be expressed in the various example embodiments, it will be evident to one skilled in the art that the example embodiments are not confined to the context of an electronic health record.

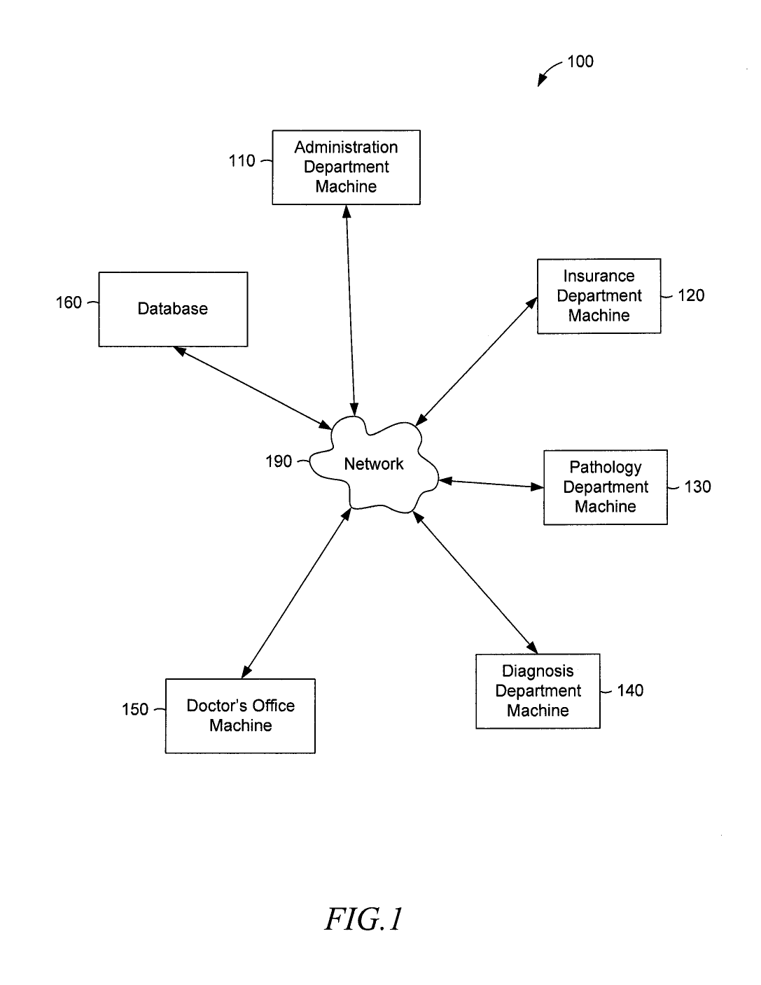

FIG. 1 is a network diagram illustrating a system 100 that includes multiple machines 110-160, according to some example embodiments. The system 100 includes an administration department machine 110, an insurance department machine 120, a pathology department machine 130, a diagnosis department machine 140, a doctor's office machine 150, and a database 160, all coupled to each other via a network 190. The machines 110-160 may be viewed as respectively corresponding to departments of a healthcare organization and may be located at one physical facility or distributed among multiple physical facilities.

For example, the administration department machine 110 may correspond to an administration department of the healthcare organization. Insurance department machine 120 may correspond to an insurance department of the healthcare organization. The pathology department machine 130 may correspond to a pathology department of the healthcare organization. The diagnosis department machine 140 may correspond to a diagnosis department of the healthcare organization, and the doctor's office machine 150 may correspond to a doctor's office of the healthcare organization. The database 160 may correspond to a central server of the healthcare organization.

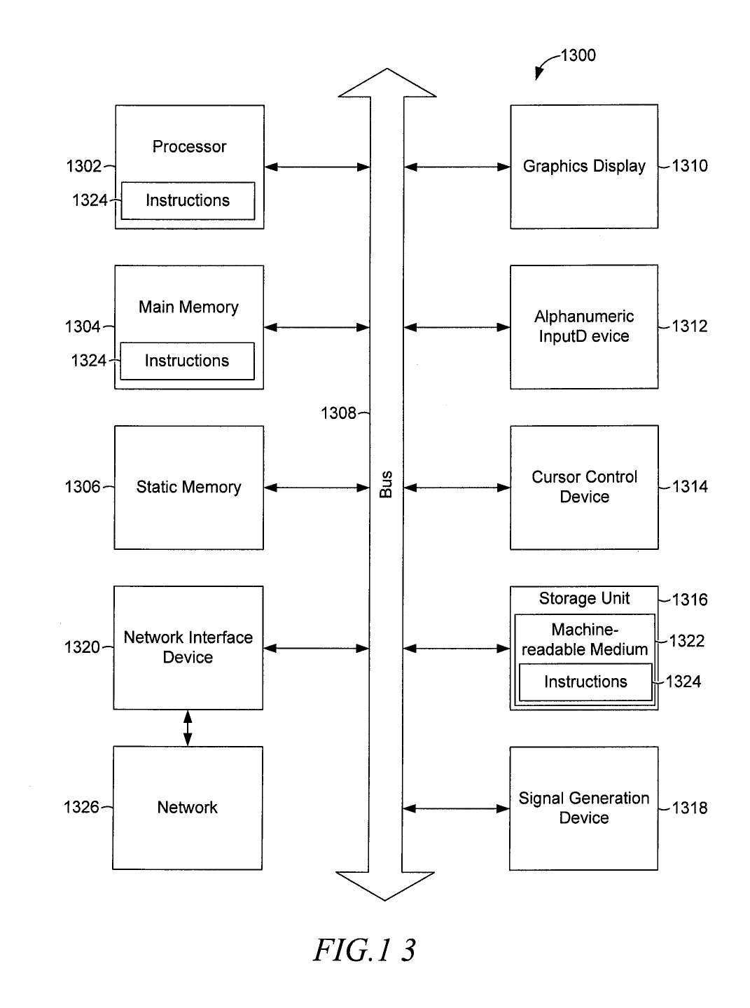

Any of the machines shown in FIG. 1 may be implemented in a general-purpose computer modified (e.g., configured or programmed) by software to be a special-purpose computer to perform the functions described herein for that machine. For example, a computer system able to implement any one or more of the methodologies described herein is discussed below with respect to FIG. 13. Moreover, any two or more of the machines illustrated in FIG. 1 may be combined into a single machine, and the functions described herein for any single machine may be subdivided among multiple machines.

The network 190 may be any network that enables communication between machines (e.g., administration department machine 110 and insurance department machine 120). Accordingly, the network 190 may be a wired network, a wireless network, or any suitable combination thereof. The network 190 may include one or more portions that constitute a private network, a public network (e.g., the Internet), or any suitable combination thereof.

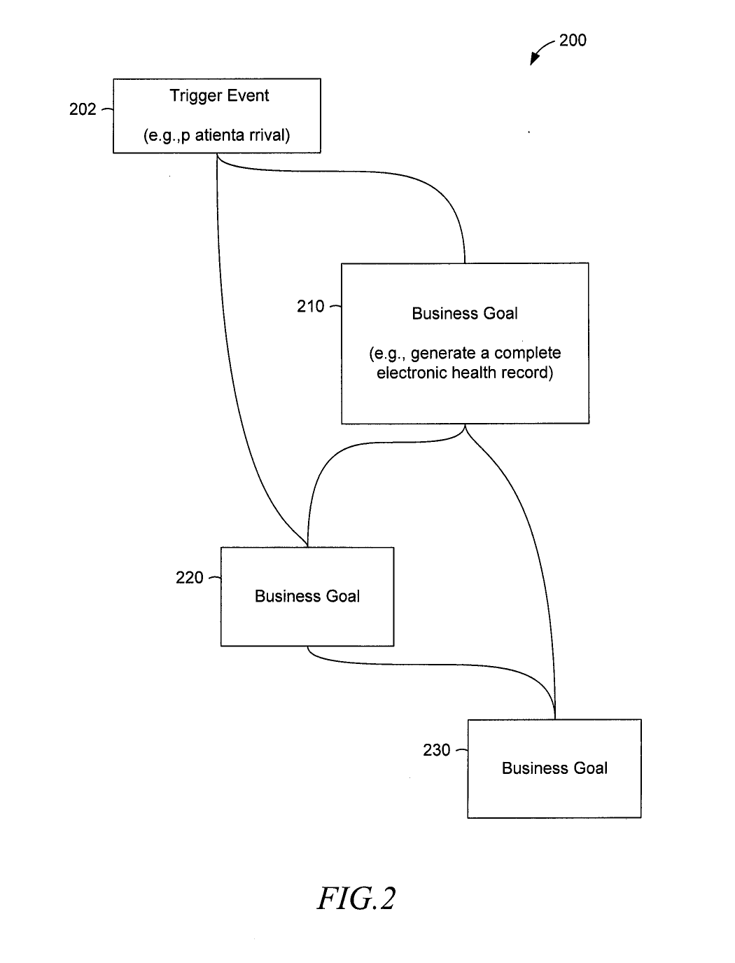

FIG. 2 is a block diagram illustrating a trigger event 202 and corresponding business goals 210-230, according to some example embodiments. As used herein, a “business goal” is an achievable objective within a workflow (e.g., workflow 200). Generally, a trigger event (e.g., trigger event 202) triggers one or more business goals (e.g., business goal 210) within the workflow. In other words, the trigger event causes one or more business goals to become pertinent to the workflow 200. As shown in FIG. 2, the trigger event 202 triggers the business goal 210 and the business goal 220.

For example, the trigger event 202 may be an arrival of a patient at a healthcare facility operated by the healthcare organization discussed above with respect to FIG. 1. The trigger event 202 triggers the business goal 210. In this example, the business goal 210 is directed to the generation of a complete electronic healthcare record for the patient. Accordingly, the arrival of the patient (e.g., trigger event 202) triggers the business goal of generating a complete electronic health record (e.g., business goal 210).

A business goal (e.g., business goal 210) may itself trigger one or more business goals (e.g., business goal 220). As shown in FIG. 2, the business goal 210 triggers business goals 220 and 230. Moreover, a business goal may be triggered by more than one business goal or trigger event (e.g., trigger event 202). FIG. 2 shows that the business goal 230 may be triggered by either the business goal 210 or the business goal 220.

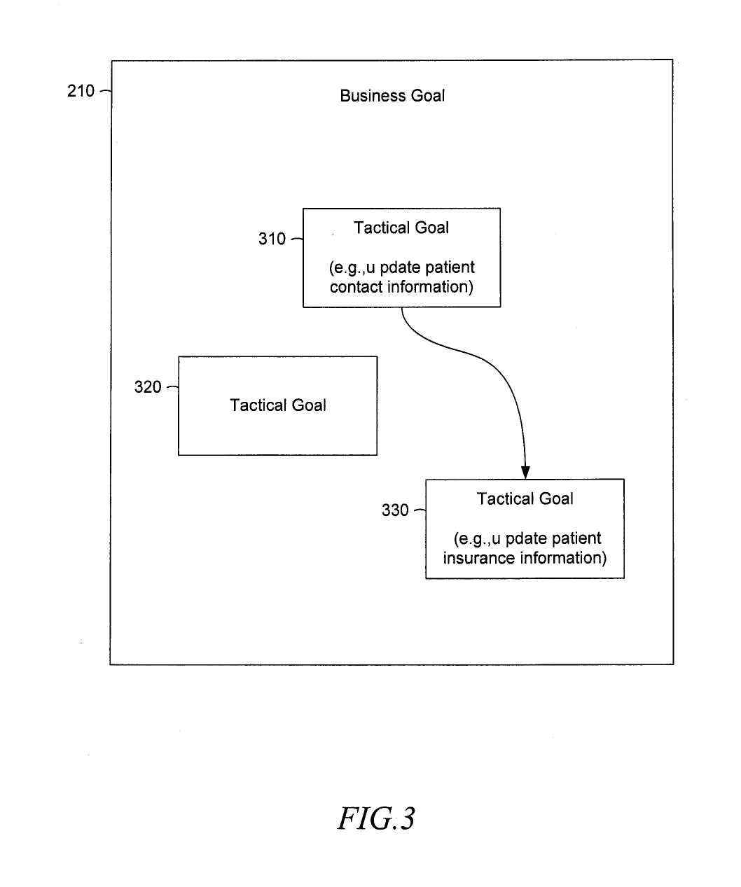

FIG. 3 is a block diagram illustrating tactical goals 310-330 included in the business goal 210. Generally, a business goal (e.g., business goal 210) may include one or more tactical goals (e.g., tactical goal 310) that are pertinent to the workflow 200. As used herein, a “tactical goal” is an achievable contribution in support of the business goal (e.g., a constituent element of the business goal, a prerequisite of the business goal, or a milestone achievement toward the business goal).

Continuing the previous example from FIG. 2, the business goal 210 of generating a complete electronic health record for the patient may include the tactical goal 310 of updating the patient's contact information (e.g., home address, phone number, or email address). Moreover, the business goal 210 may include the tactical goal 330 of updating the patient's insurance information (e.g., carrier name, group number, or policy number).

A tactical goal (e.g., tactical goal 320) may be attainable at any time (e.g., immediately) or may be attainable only after attaining one or more further tactical goals. As shown in FIG. 3, the tactical goal 310 is attainable without any prerequisites, but the tactical goal 330 is attainable only after attaining the tactical goal 310. This relationship may be represented by ordinal information. As used herein, “ordinal information” refers to data that indicates a sequential order. Examples of ordinal information include ordering data, sequencing data, prerequisite data, or dependency data. The relationship between the tactical goals 310 and 330 is shown by an arrow in FIG. 3, the arrow representing ordinal information indicating that the tactical goal 310 is to be attained ahead of the tactical goal 330. The tactical goal 320 is attainable at any time.

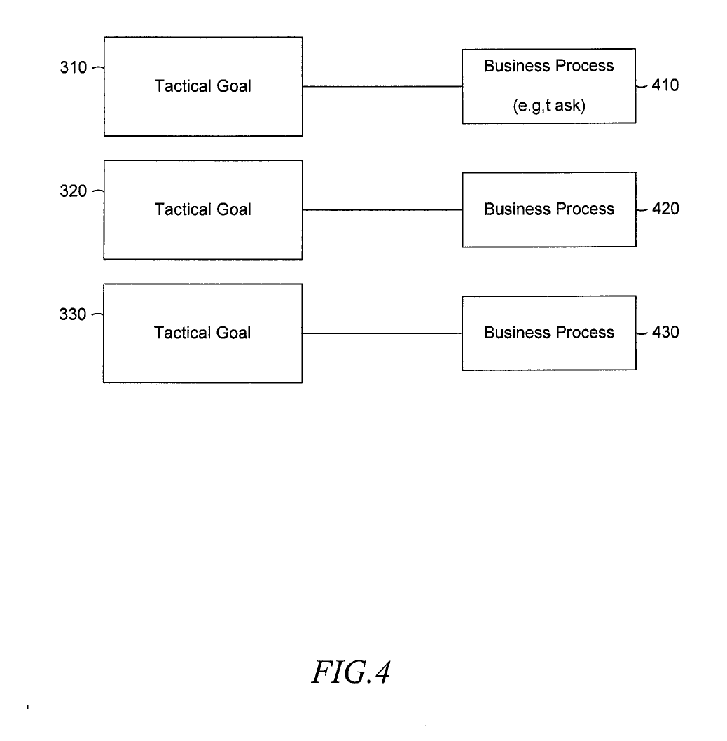

FIG. 4 is a diagram illustrating business processes 410-430 that respectively correspond to the tactical goals 310-330, according to some example embodiments. These correspondence relationships are shown by straight lines in FIG. 4. Specifically, the business process 410 corresponds to the tactical goal 310; the business process 420 corresponds to the tactical goal 320; and the business process 430 corresponds to the tactical goal 330.

Generally, a tactical goal (e.g., tactical goal 310) may be attained by execution of a business process (e.g., business process 410). A business process represents a task that may be performed by an organizational subdivision (e.g., a department of a healthcare organization). Performance of the task by the organizational subdivision may include an activity performed by a human, by a machine, or both. Since the tactical goals 310-330 are pertinent to the workflow 200, the corresponding business processes 410-430 are similarly pertinent to the workflow 200.

Continuing the previous example from FIG. 2-3, the tactical goal 310 of updating the patient's contact information may correspond to the business process 410 of requesting and receiving contact information from the patient. The requesting and the receiving of the contact information constitute a task that is pertinent to the workflow 200. This task may be performed by the administration department of the healthcare organization, which may utilize the administration department machine 110 in performing the task.

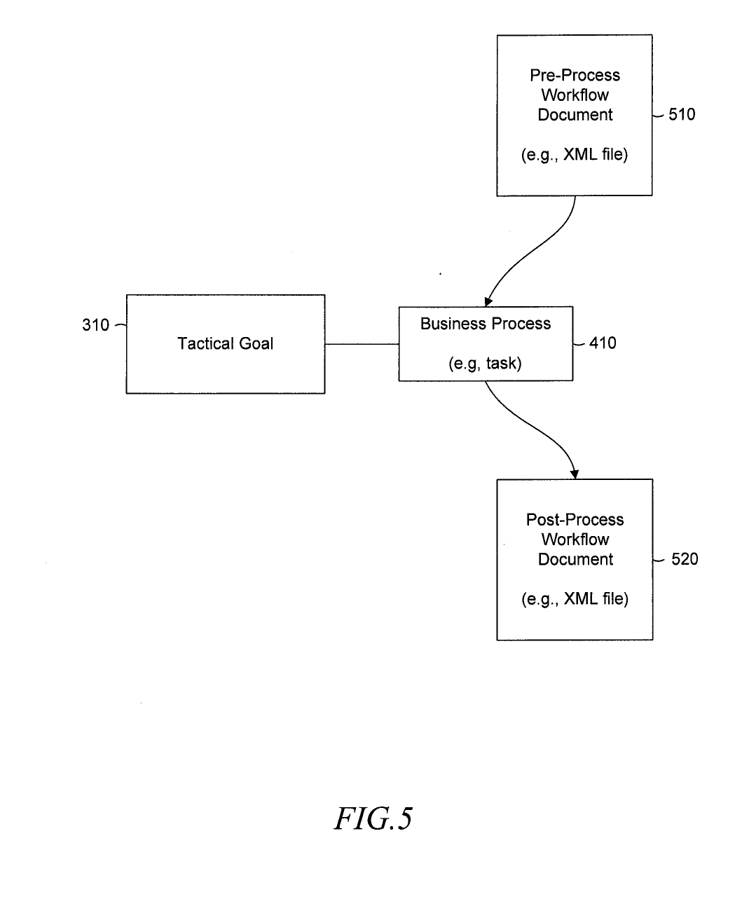

FIG. 5 is a diagram of the business process 410 facilitating generation of a post-process workflow document 520 based on a pre-process workflow document 510, according to some example embodiments. As noted above, the business process 410 corresponds to the tactical goal 310. As indicated by arrows, the business process 410 (e.g., a task) may be used to generate the post-process workflow document 520 or a portion thereof. The generation may be based on the pre-process workflow document 510 or a portion thereof.

As used herein, “pre-process” means prior to execution of a business process (e.g., business process 410), and “post-process” means after execution of the business process. The terms “pre-process” and “post-process” are applied relative to a particular business process. Accordingly, the pre-process workflow document is a version of a workflow document prior to execution of the business process 410. The post-process workflow document 520 is a version of the same workflow document after execution of the same business process 410.

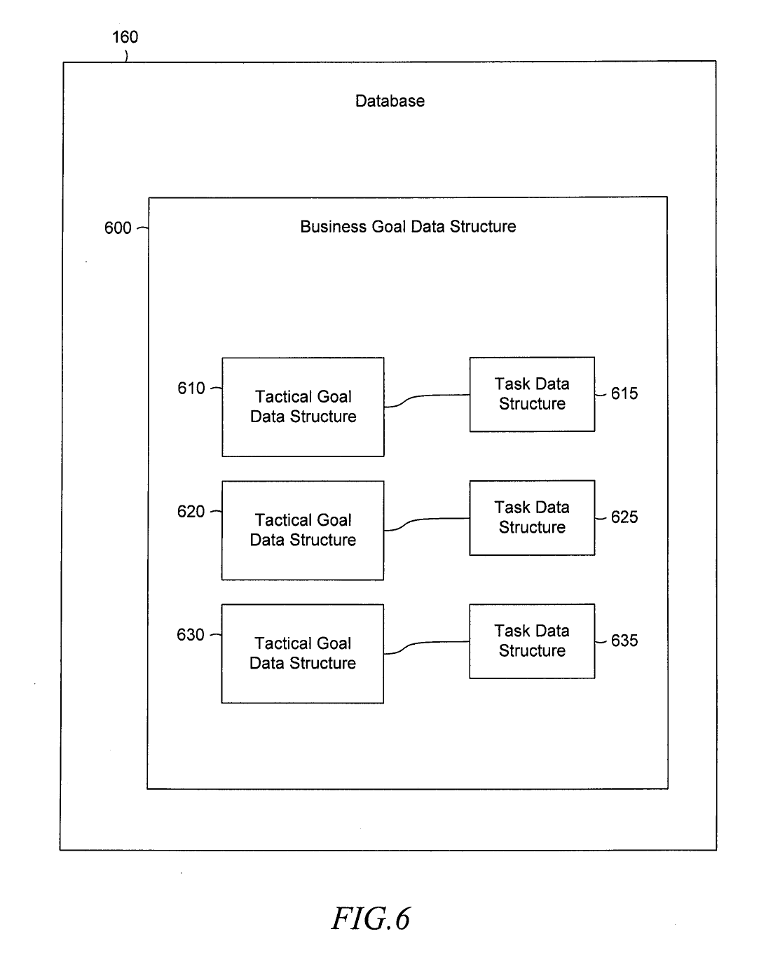

FIG. 6 is a block diagram illustrating the database 160 storing a business goal data structure 600 with tactical goal data structures 610, 620, and 630, as well as task data structures 615, 625, and 635, according to some example embodiments. As indicated by lines in FIG. 6, the tactical goal data structures 610 corresponds to the task data structure 615. Moreover, the tactical goal data structure 620 corresponds to the task data structure 625, and similarly, the tactical goal data structure 630 corresponds to the task data structure 635.

The business goal data structure 600 is a body of data that models the business goal 210. Any suitable process modeling language may be used to model the business goal 210. For example, the business goal 210 may be represented using business process modeling notation (BPMN), business process execution language (BPEL), or any suitable combination thereof.

The tactical goal data structures 610, 620, and 630 are bodies of data that respectively model the tactical goals 310, 320, and 330. Since the tactical goals 310-330 are included in the business goal 210 (as shown in FIG. 3), the tactical goal data structures 610, 620, and 630 are included in the business goal data structure 600. Any one or more of the tactical goal data structures 610, 620, and 630 may accordingly be represented using BPMN, BPEL, or any suitable combination thereof. For example, the tactical goal data structure 610 models the tactical goal 310 and hence corresponds to the tactical goal 310.

The task data structures 615, 625, and 635 are bodies of data that respectively model business processes 410, 420, and 430. In other words, the task data structures 615, 625, and 635 model tasks that respectively correspond to the business processes 410, 420, and 430. These correspondence relationships may be stored in the business goal data structure 600, as shown by wavy lines in FIG. 6. For example, the task data structure 615 models a task that corresponds to the tactical goal data structure 610 and hence corresponds to the tactical goal data structure 610, which in turn corresponds to the tactical goal 310 and to the business process 410. Accordingly, the task data structure 615 also corresponds to the tactical goal 310 and to the business process 410.

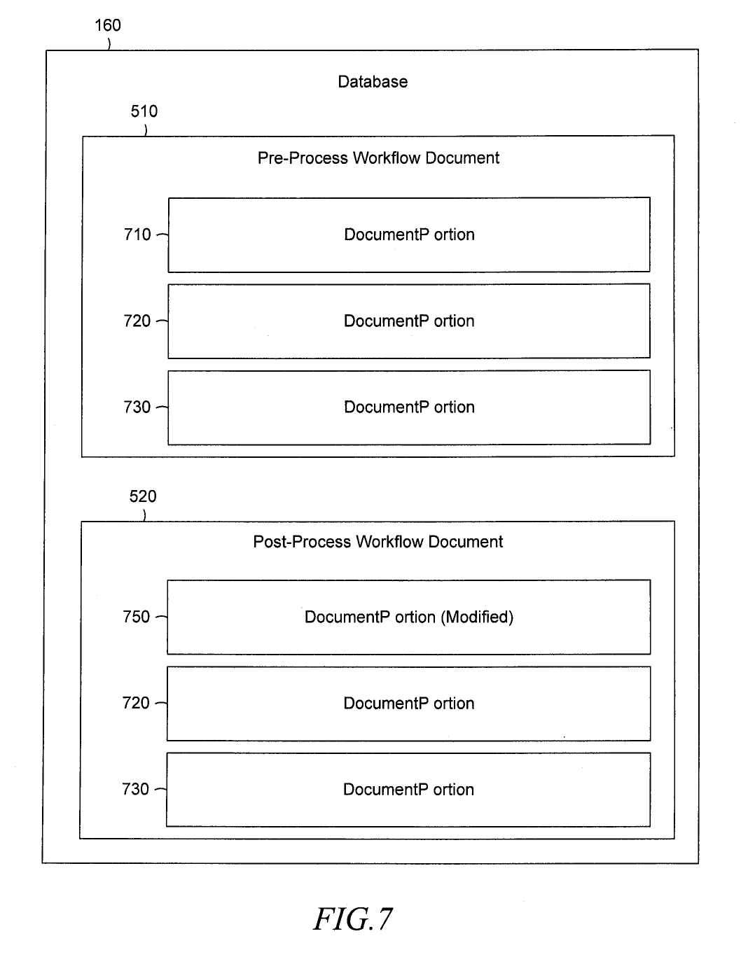

FIG. 7 is a block diagram of the database 160 storing the pre-process workflow document 510 and the post-process workflow document 520, according to some example embodiments. The database 160 may store the pre-process workflow document 510, the post-process workflow document 520, or both, simultaneously while storing the business goal data structure 610 (as shown in FIG. 6).

The pre-process workflow document 510 includes one or more document portions 710-730. The post-process workflow document 520 includes one or more document portions 720, 730, and 750. The pre-process workflow document 510, a post-process workflow document 520, or both, may be any kind of document able to store data pertinent to the workflow 200. In particular, the data may be pertinent to a tactical goal data structure (e.g., tactical goal data structure 610), a tactical goal (e.g., tactical goal 310), a task data structure (e.g., task data structure 615), a business process (e.g., business process 410), or any suitable combination thereof. Moreover, the data may include business process data resultant from one or more business processes (e.g., tasks) pertinent to the workflow 200. In various example embodiments, the pre-process workflow document 510 and the post-process workflow document 520 are implemented as XML documents, hypertext markup language (HTML) documents, documents using a proprietary format (e.g., Microsoft Word or Adobe Portable Document Format (PDF)), or any suitable combination thereof.

The database 160 may store one or more documents as stateless documents with respect to the workflow 200. For example, the database 160 may use a file system to organize the documents stored thereon. Metadata of the file system may correspond to a particular document and indicate state or status of the document with respect to the file system (e.g., date of creation, date last modified, owner, read permissions, or write permissions). In various example embodiments, however, the metadata conveys no information about any state or status of the document with respect to the workflow 200, thus maintaining the particular document as a stateless document with respect to the workflow 200. Accordingly, the database 160 may store documents in a file system devoid of any metadata that indicates state or status of the document with respect to the workflow 200.

As shown in FIG. 7, the pre-process workflow document 510 and the post-process workflow document 520 each include the document portion 720 and the document portion 730. The pre-process workflow document 510, however, includes the document portion 710, while the post-process workflow document 520 does not include the document portion 710. Instead, the post-process workflow document 520 includes the document portion 750, which is a modified version of the document portion 710, as noted in FIG. 7.

In some example embodiments, the pre-process workflow document 510 is accessed by a machine (e.g., the administration department machine 110), and the post-process workflow document 520 is generated by the machine using data resultant from a business process (e.g., business process 410). The machine may then store the post-process workflow document 520 in the database 160. For example, the post-process workflow document 520 may be stored by one machine (e.g., the administration department machine 110) as a pre-process workflow document for another machine (e.g., the insurance department machine 120), which in turn may generate its own post-process workflow document based on data resultant from another business process (e.g., business process 420). Accordingly, multiple subdivisions within an organization may collaboratively execute respective portions of the workflow by modifying a workflow document, which for any given business process, is modified from a pre-process workflow document to a post-process workflow document.

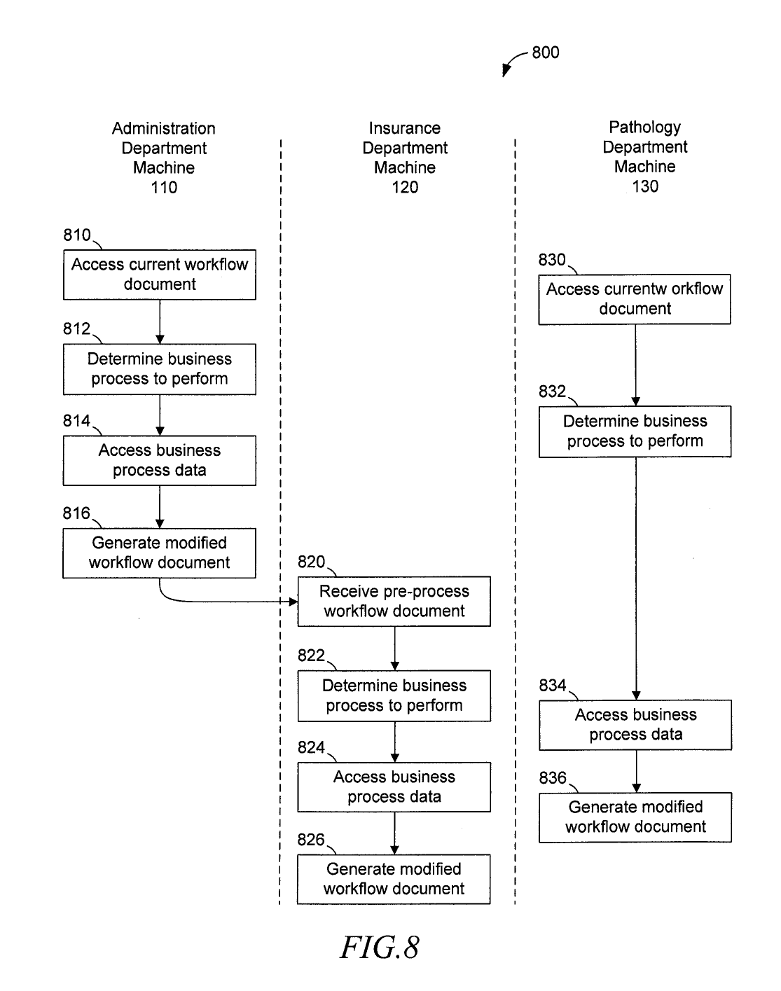

FIG. 8 is a flowchart illustrating a method 800 performed by three machines in support of a workflow (e.g., workflow 200), according to some example embodiments. In the example shown, the three machines are the administration department machine 110, the insurance department machine 120, and the pathology department machine 130.

In operation 810, the administration department machine 110 accesses a workflow document that is pertinent to a business goal (e.g., business goal 210) triggered by a trigger event (e.g., trigger event 202). The workflow document may be referred to as a “current” workflow document, being pertinent to the current business goal. The administration department machine 110 accesses the current workflow document as a pre-process workflow document relative to the administration department machine 110. For example, the current workflow document may be accessed by reading it from the database 160.

As an example of operation 810, suppose that the trigger event 202 is the arrival of the patient, as discussed above with respect to FIG. 2, and that the business goal 210 of generating a complete electronic health care record for the patient has been triggered. This business goal 210 is modeled by the business goal data structure 600, as shown in FIG. 3, and includes the tactical goal 310 of updating the patient's contact information, as shown in FIG. 6. This tactical goal 310 is modeled by the tactical goal data structure 610, as shown in FIG. 6, and the corresponding business process 410, as shown in FIG. 5, is modeled by the task data structure 615, as shown in FIG. 6. Accordingly, the task of updating the patient's contact information is modeled by the task data structure 615 (e.g., using a process modeling language).

In this example, the updating of the patient's contact information involves accessing an electronic health care record for the patient. The electronic health care record of the patient stores the contact information for the patient (e.g., a home address of the patient). Accordingly, this electronic health care record constitutes the current workflow document for the current business goal 210. Hence, in operation 810, the administration department machine 110 accesses the electronic health care record as a pre-process workflow document (e.g., pre-process workflow document 510) relative to the administration department machine 110.

In operation 812, the administration department machine 110 determines that a business process (e.g., business process 410) is to be performed. The business process may be determined (e.g., selected) based on a business goal data structure (e.g., business goal data structure 600), a tactical goal data structure (e.g., tactical goal data structure 610), a task data structure (e.g., task data structure 615), or any suitable combination thereof. Continuing the above example, the administration department machine 110 may determine that requesting and receiving the patient's current contact information is the business process to be performed. Not shown in FIG. 8 are operations performed by the administration department machine 110 in requesting and receiving the patient's current contact information. For the purposes of describing the method 800, it is assumed that business processes are executed to completion. Accordingly, it is assumed that the administration department machine 110 successfully communicates a request that the patient provide his or her current contact information and that the administration department machine 110 successfully receives updated contact information of the patient. For example, the administration department machine 110 may receive an updated home address of the patient (e.g., as entered by an employee working at the administration department machine 110).

In operation 814, the administration department machine 110 accesses business process data that results from the business process (e.g., business process 410) determined in operation 812. The business process data may include results from execution of the business process. Continuing the above example, the administration department machine 110 may receive the patient's current contact information (e.g., as submitted by the patient or as entered by an employee of the healthcare organization). For example, administration department machine 110 may access (e.g., read from a memory or from the database 160) the updated home address of the patient.

In operation 816, the administration department machine 110 generates a modified workflow document (e.g., a modified version of the current workflow document) based on the business process data accessed in operation 814. For example, the modified workflow document may be generated by generating a post-process workflow document relative to the administration department machine 110, where the post-process workflow document includes the patient's current contact information. Continuing the above example, the administration department machine may generate a version of the patient's electronic health record that replaces the patient's previous home address with the patient's updated home address, thereby completing the task modeled by the task data structure 615. In other words, with reference to FIG. 7, the document portion 710 in the pre-process workflow document 510 may store the patient's previous home address, and the document portion 750 in the post-process workflow document 520 may store the patient's updated home address. The administration department machine 110 may further store the modified workflow document (e.g., in the database 160) or may transmit the modified workflow document to another machine (e.g., to the insurance department machine 120).

In operation 820, the insurance department machine 120 accesses the modified workflow document as a pre-process workflow document (e.g., pre-process workflow document 510) relative to the insurance department machine 120. For example, the insurance department machine 120 may read the pre-process workflow document 510 from the database 160 or may receive the pre-process workflow document 510 from another machine (e.g., the administration department machine 110).

In operation 822, the insurance department machine 120 determines that a business process (e.g., business process 420) is to be performed. Similar to operation 812, the business process may be determined (e.g., selected) based on a business goal data structure (e.g., business goal data structure 600), a tactical goal data structure (e.g., tactical goal data structure 620), a task data structure (e.g., task data structure 625), or any suitable combination thereof. For example, the insurance department machine 120 may determine that requesting and receiving the patient's current insurance information is the business process to be performed.

In operation 824, the insurance department machine 120 accesses business process data that results from the business process (e.g., business process 420) determined in operation 822. The business process data may include results from execution of the business process. For example, the insurance department machine 120 may receive the patient's current insurance information (e.g., as submitted by an insurance carrier or as entered by an employee of the healthcare organization).

In operation 826, the insurance department machine 120 generates a modified workflow document (e.g., post-process workflow document 520) based on the business process data accessed in operation 824. For example, the modified workflow document may be generated by generating a post-process workflow document relative to the insurance department machine 120, where the post-process workflow document includes the patient's current insurance information. The insurance department machine 120 may further store the modified workflow document (e.g., in the database 160) or may transmit the modified workflow document to another machine (e.g., doctor's office machine 150).

Operations 830-836 may be performed by the pathology department machine 130 in parallel with operations 810-826. For example, the healthcare organization may have a policy that pathology-related goals need not wait for completion of administration-related goals or insurance-related goals. Accordingly, the pathology department machine 130 may perform operations 830-836 immediately after the trigger event (e.g., trigger event 202), for example, in support of another business goal (e.g., business goal 220) pertinent to a workflow (e.g., workflow 200).

In operation 830, the pathology department machine 130 accesses the current workflow document as a pre-process workflow document relative to the pathology department machine 130. For example, the pathology department machine 130 may read or receive the current workflow document.

In operation 832, the pathology department machine 130 determines that a business process (e.g., business process 430) is to be performed. The business process may be determined based on a business goal data structure, a tactical goal data structure, a task data structure, or any suitable combination thereof. For example, the pathology department machine 130 may determine that analyzing a sample of blood taken from the patient is the business process to be performed.

In operation 834, the pathology department machine 130 accesses business process data that results from the business process (e.g., business process 430) determined in operation 832. The business process data may include results from execution of the business process. For example, the pathology department machine 130 may receive an analysis of the sample of blood taken from the patient (e.g., as transmitted by a blood analysis device or as entered by an employee of the healthcare organization).

In operation 836, the pathology department machine 130 generates a modified workflow document (e.g., a modified version of the current workflow document) based on the business process data accessed in operation 834. For example, the modified workflow document may be generated by generating a post-process workflow document relative to the pathology department machine 130, where the post-process workflow document includes the analysis of the sample of blood taken from the patient. The pathology department machine 130 may further store the modified workflow document (e.g., in the database 160) or may transmit the modified workflow document to another machine (e.g., to the diagnosis department machine 140).

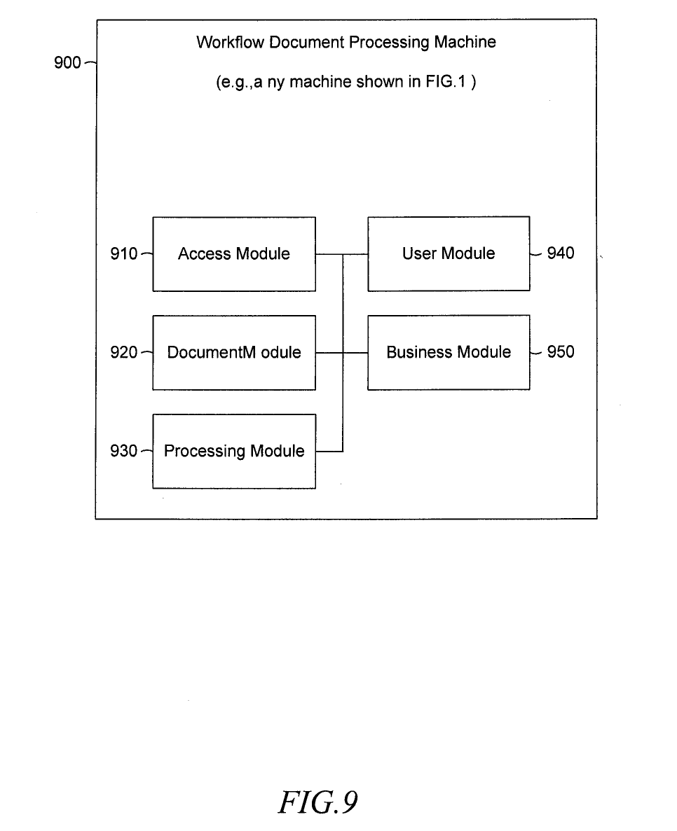

FIG. 9 is a block diagram illustrating components of a workflow document processing machine 900, according to some example embodiments. Any one or more of the machines shown in FIG. 1 (e.g., administration department machine 110) may be implemented using the workflow document processing machine 900. The workflow document processing machine 900 includes an access module 910, a document module 920, a processing module 930, a user module 940, and a business module 950, all configured to communicate with each other (e.g., via a bus, a shared memory, or a switch). Any one or more of these modules may be implemented using hardware or a combination of hardware and software. Moreover, any two or more of these modules may be combined into a single module, and the functions described herein for a single module may be subdivided among multiple modules.

The access module 910 is configured to access the pre-process workflow document 510 or a portion thereof (e.g., document portion 710). The access module 910 is also configured to access the business goal data structure 600. Moreover, the access module 910 is configured to access a tactical goal data structure (e.g., tactical goal data structure 610) included in the business goal data structure 600.

Additionally, the access module 910 is further configured to access business process data resultant from execution of a business process (e.g., business process 410) that corresponds to the tactical goal data structure 610. In some example embodiments, the business process data indicates a completion of the business process. In certain example embodiments, the business process data includes results from execution (e.g., to completion) of the business process. To access some or all of the above-mentioned information, the access module 910 may read information (e.g., from the database 160), receive information (e.g., via the network 190), or any suitable combination thereof.

The document module 920 is configured to modify a document portion (e.g., document portion 710) included in the pre-process workflow document 510. The document module 920 may modify the document portion based on the business process data accessed by the access module 910. The modifying of the document portion by the document module 920 may further be based on a task data structure (e.g., task data structures 615) that corresponds to the tactical goal data structure 610. For example, the task data structure may indicate how the document portion is to be modified by the business process data (e.g., by specifying a syntax or format of the document portion).

The processing module 930 is configured to generate the post-process workflow document 520 based on the pre-process workflow document 510 and based on the modified document portion (e.g., document portion 750). The processing module 930 may assemble (e.g., concatenate or merge) the post-process workflow document 520 from the modified document portion 750 and one or more unmodified document portions (e.g., document portions 720 and 730). In certain example embodiments, the processing module 930 communicates the post-process workflow document 520 to another machine (e.g., another workflow document processing machine) via the network 190. According to various example embodiments, the processing module 930 stores the post-process workflow document 520 (e.g., in the database 160) for access by another machine (e.g., another workflow document processing machine) via the network 190.

The user module 940 is configured to interface with a user of the workflow document processing machine 900. The user module 940 may present a user interface to the user and receive user input via the user interface. The user input may include one or more tactical goal data structures (e.g., tactical goal data structure 610), one or more tactical goals (e.g., tactical goal 310), one or more task data structures (e.g., task data structure 615), one or more business processes (e.g., business process 410), or any suitable combination thereof.

In various example embodiments, the user input includes search parameters submitted as a query of the database 160. The database 160 may include a database record that specifies (e.g., includes or references) one or more tactical goal data structures (e.g., tactical goal data structure 610), one or more tactical goals (e.g., tactical goal 310), one or more task data structures (e.g., task data structure 615), one or more business processes (e.g., business process 410), or any suitable combination thereof. The database record may include a semantic annotation (e.g., keyword), and the database 160 may be indexed based on semantic annotations of database records. The search parameters submitted in the user input may include the semantic annotation to identify the database record.

The business module 950 is configured to generate the business goal data structure 600. The business module 950 may generate the business goal data structure 600 based on one or more tactical goal data structures (e.g., tactical goal data structure 610), one or more tactical goals (e.g., tactical goal 310), one or more task data structures (e.g., task data structure 615), one or more business processes (e.g., business process 410), or any suitable combination thereof.

To generate the business goal data structure 600, the business module 950 may initiate a query of the database 160, based on the semantic annotation (e.g., keyword) and identify a database record that specifies one or more tactical goal data structures (e.g., tactical goal data structure 610), one or more tactical goals (e.g., tactical goal 310), one or more task data structures (e.g., task data structure 615), one or more business processes (e.g., business process 410), or any suitable combination thereof. The query may be based on search parameters submitted with a user input received by the user module 940, and the identification of the database record may be based on the semantic annotation. The business module 950 is further configured to access the identified database record in the database 160.

According to various example embodiments, the business module 950 is further configured to determine a task status of a business process (e.g., business process 410) pertinent to a workflow (e.g., workflow 200). The task status indicates a state of the business process. As such, the task status corresponds to a tactical goal (e.g., tactical goal 310), to a tactical goal data structure (e.g., tactical goal data structure 610), and to a task data structure (e.g., task data structure 615) corresponding to the business process. The task status may indicate whether the business process was successfully executed (e.g., to completion) and may indicate whether the business process is currently executable (e.g., having met all prerequisites, if any).

In certain example embodiments, the task status conveys no information about any state or status of the current workflow document (e.g., pre-process workflow document 510 or post-process workflow document 520), which is maintained as a stateless document. In other words, the task status may indicate a state of a task, which is not a state of the current workflow document.

In some example embodiments, the business module 950 is further configured to determine an execution status of a workflow (e.g., workflow 200). The execution status of the workflow describes an overall state of the workflow in terms of its pertinent business goals (e.g., business goal 210) and tactical goals (e.g., tactical goal 310). As noted above, business goals and tactical goals may be respectively modeled by business goal data structures and tactical goal data structures, and a tactical goal data structure may have a corresponding task data structure that models a task to be performed to attain the corresponding tactical goal. The execution status may include the task status for one or more tasks of the workflow. In various example embodiments, the execution status is a data structure that aggregates multiple task statuses for multiple tasks of the workflow. Accordingly, the execution status may indicate whether multiple business processes (e.g., business process 410-430) were successfully executed (e.g., to completion) and may indicate whether one or more business processes are currently executable (e.g., having that all prerequisites, if any).

The execution status may further include ordinal information (e.g., ordering, sequencing, prerequisite, or dependency data) for one or more tasks modeled by one or more task data structures (e.g., task data structure 615). The ordinal information may indicate whether a business process (e.g., business process 410) is executable prior to a further business process (e.g., business process 420) pertinent to a workflow (e.g., workflow 200).

According to various example embodiments, the execution status conveys no information about any state or status of the current workflow document (e.g., pre-process workflow document 510 or post-process workflow document 520), which is maintained as a stateless document. In other words, the execution status may indicate a state of the workflow (e.g., workflow 200), which is not the same as a state of the current workflow document.

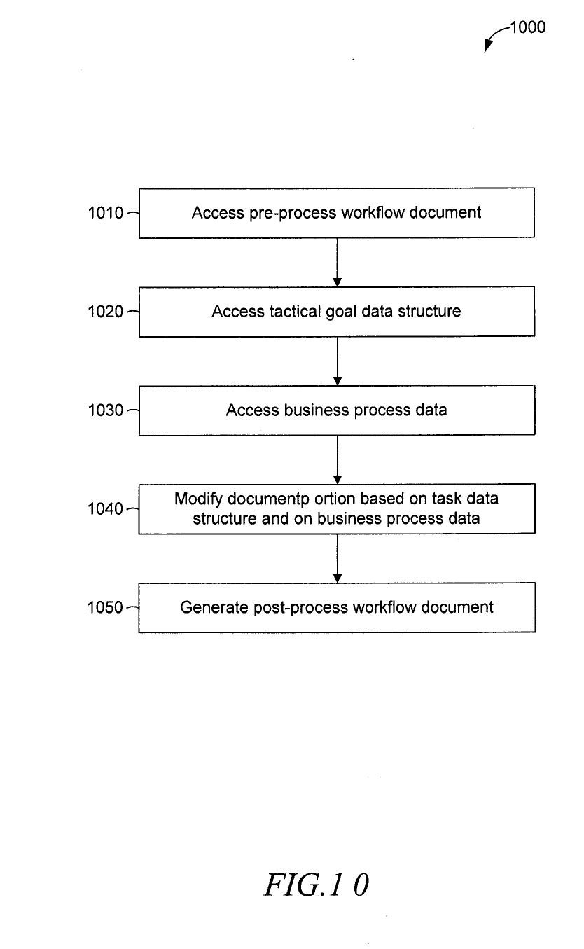

FIG. 10-12 are flowcharts illustrating operations in a method 1000 of agile workflow modeling and execution based on a document, according to some example embodiments. Operations in the method 1000 may be performed by the workflow document processing machine 900, using modules described above with respect to FIG. 9.

As shown in FIG. 10, the access module 910 accesses the pre-process workflow document 510 in operation 1010. As noted above, the pre-process workflow document includes multiple document portions (e.g., document portion 710). In operation 1020, the access module 910 accesses the tactical goal data structure 610, which is stored in the database 160. In operation 1030, the access module 910 accesses business process data resultant from execution (e.g., to completion) of the business process 410 that corresponds to the tactical goal data structure 610.

In operation 1040, the document module 920 modifies the document portion 710, thus obtaining the modified document portion 750. Modification of the document portion 710 may be based on the task data structure 615 and on the business process data accessed in operation 1030.

In operation 1050, the processing module 930 generates the post-process workflow document 520. The generation of the post-process workflow document 520 is based on the pre-process workflow document 510 (e.g., based on the document portions 720-730) and based on the modified document portion 750 obtained in operation 1040.

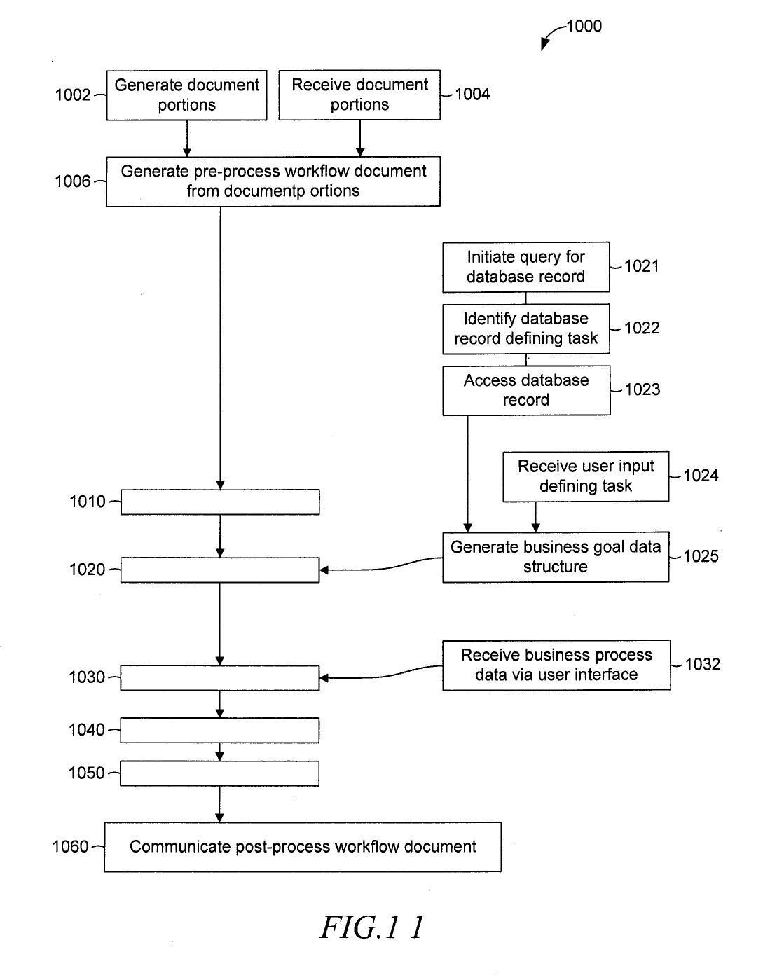

Turning now to FIG. 11, in some example embodiments, the document module 920 generates one or more document portions (e.g., document portions 710-730) of the pre-process workflow document 510 in operation 1002. Generation of a document portion may be based on information accessed by the access module 910. Specifically, the document module 920 may generate a document portion based on one or more tactical goal data structures (e.g., tactical goal data structure 610), one or more tactical goals (e.g., tactical goal 310), one or more task data structures (e.g., task data structure 615), one or more business processes (e.g., business process 410), or any suitable combination thereof.

In certain example embodiments, one or more document portions (e.g., document portion 710-730) are generated by a device external to the workflow document processing machine 900. A document portion may be stored (e.g., in the database 160) and accessed (e.g., received) by the access module 910 in operation 1004. For example, the access module 910 may access the document portion via the network 190. Alternatively, operation 1004 may be performed by the user module 940, which may receive a document portion submitted by a user of the workflow document processing machine 900.

In operation 1006, the document module 920 generates the pre-process workflow document 510 from one or more document portions (e.g., document portions 710-730), which may be accessed (e.g., received) in operation 1002, operation 1004, or any suitable combination thereof. The document module 920 may then store the generated pre-process workflow document 510 in the database 160.

In operation 1021, the business module 950 initiates a query of the database 160. The query may be based on one or more search parameters submitted with user input received by the user module 940 and may seek to identify a database record corresponding to a semantic annotation (e.g., keywords) that matches one or more of the search parameters. As noted above, the database record sought may specify (e.g., include or reference) one or more tactical goal data structures (e.g., tactical goal data structure 610), one or more tactical goals (e.g., tactical goal 310), one or more task data structures (e.g., task data structure 615), one or more business processes (e.g., business process 410), or any suitable combination thereof.

In operation 1022, the business module 950 identifies the database record for access by the access module 910. Accordingly, in operation 1023, the access module 910 accesses the identified database record.

In operation 1024, the user module receives user input that defines one or more business processes (e.g., tasks) to be performed in support of a workflow (e.g., workflow 200). For example, the user input may specify (e.g., include or reference) one or more tactical goal data structures (e.g., tactical goal data structure 610), one or more tactical goals (e.g., tactical goal 310), one or more task data structures (e.g., task data structure 615), one or more business processes (e.g., business process 410), or any suitable combination thereof.

Based on information accessed (e.g., received) in operations 1021-1023, in operation 1024, or in any suitable combination thereof, the processing module 930 may generate the business goal data structure 600 in operation 1025. The processing module 930 may store the business goal data structures 600 in the database 160 for access by the access module 910 in operation 1020. In some example embodiments, the processing module 930 provides the business goal data structure 600 to the access module 910 directly (e.g., via a bus, a shared memory, or a switch).

In operation 1032, the user module 940 receives business process data resultant from the execution (e.g., to completion) of the business process 410. For example, the user module 940 may present a user interface to the user of the workflow document processing machine 900 and receive the business process data via the user interface. The user module 940 may store the business process data in the database 160 for access by the access module 910 in operation 1030. In some example embodiments, the user module 940 provides the business process data to the access module 910 directly (e.g., via a bus, a shared memory, or a switch).

In operation 1060, the processing module 930 communicates the post-process workflow document 920 to another machine (e.g., another workflow document processing machine) via the network 190. This communication may be a direct transmission of the post-process workflow document 520 to the other machine. Alternatively, this communication may be an indirect transmission of the post-process workflow document 520 by storing the post-process workflow document 520 in a storage facility (e.g., database 160) accessible by another machine.

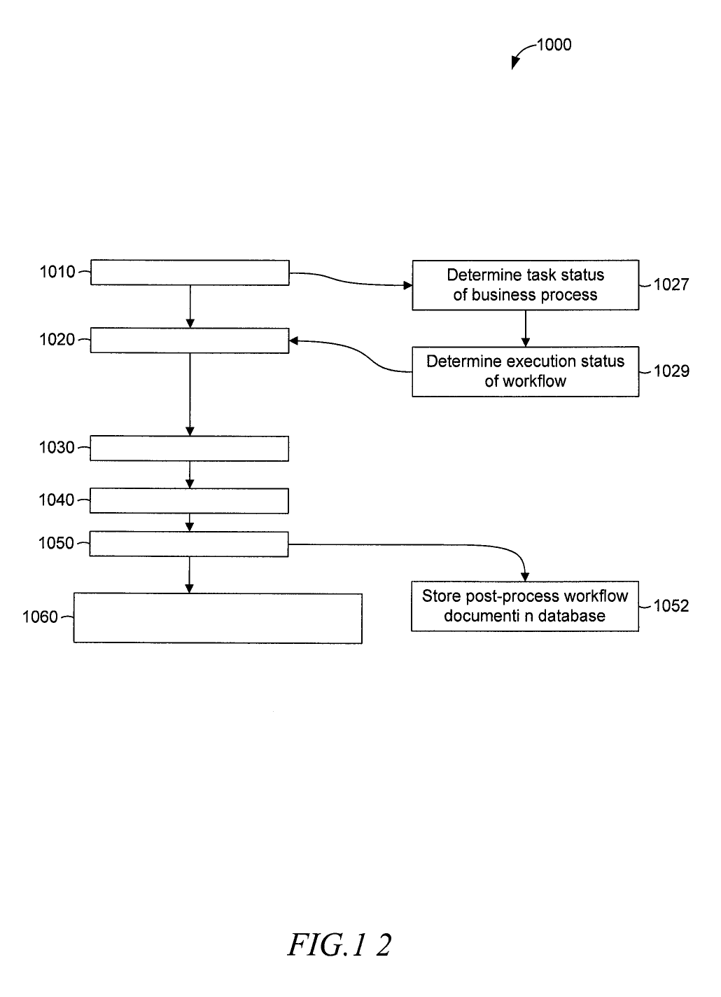

Turning now to FIG. 12, according to various example embodiments, the business module 950 performs operations 1027 and 1029. These operations may be performed prior to performance of operation 1020 by the access module 910.

In operation 1027, the business module 950 determines a task status of the business process 410, as described above with respect to FIG. 9. In operation 1029, the business module 950 determines an execution status of the workflow (e.g., workflow 200), as described above with respect to FIG. 9. As noted above, the execution status of the workflow may include the task status of the business process 410.

In operation 1052, the processing module 930 stores the post-process workflow document 520 (e.g., in the database 160). The post-process workflow document 520 may be stored for access by another machine (e.g., another workflow document processing machine) via the network 190.

According to various example embodiments, one or more of the methodologies described herein may facilitate an agile modeling of a workflow, an agile execution of the workflow, or any suitable combination thereof. In particular, the methodologies described herein enable the modeling of one or more business processes (e.g., business process 410) to be dynamic in that business processes or their sequence of execution need not be defined prior to runtime. This may have the effect of providing increased flexibility for participants in the workflow (e.g., employees of the healthcare organization), and the increased flexibility may be available at modeling time, at execution time, or both. Features related to identification of a database record that specifies task-related information may enable reuse of existing tasks, which may reduce effort and resources expended in programming services, applications, or other functionality pertinent to the workflow. Accordingly, one or more the methodologies discussed herein may obviate a need for certain efforts or resources. These resources include computing resources used by one or more devices within the system 100. Examples of such computing resources include processor cycles, network traffic, memory usage, storage space, power consumption, and cooling capacity.

FIG. 13 illustrates components of a machine 1300, according to some example embodiments, that is able to read instructions from a machine-readable medium (e.g., a machine-readable storage medium) and perform any one or more of the methodologies discussed herein. Specifically, FIG. 13 shows a diagrammatic representation of the machine 1300, in the example form of a computer system, within which instructions 1324 (e.g., software) for causing the machine 1300 to perform any one or more of the methodologies discussed herein may be executed. In alternative embodiments, the machine 1300 operates as a standalone device or may be connected (e.g., networked) to other machines. In a networked deployment, the machine 1300 may operate in the capacity of a server machine or a client machine in a server-client network environment, or as a peer machine in a peer-to-peer (or distributed) network environment. The machine 1300 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1324 (sequentially or otherwise) that specify actions to be taken by that machine. Further, while only a single machine is illustrated, the term “machine” shall also be taken to include a collection of machines that individually or jointly execute the instructions 1324 to perform any one or more of the methodologies discussed herein.

The machine 1300 includes a processor 1302 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1304, and a static memory 1306, which are configured to communicate with each other via a bus 1308. The machine 1300 may further include a graphics display 1310 (e.g., a plasma display panel (PDP), a liquid crystal display (LCD), a projector, or a cathode ray tube (CRT)). The machine 1300 may also include an alphanumeric input device 1312 (e.g., a keyboard), a cursor control device 1314 (e.g., a mouse, a touchpad, a trackball, a joystick, a motion sensor, or other pointing instrument), a storage unit 1316, a signal generation device 1318 (e.g., a speaker), and a network interface device 1320.

The storage unit 1316 includes a machine-readable medium 1322 on which is stored the instructions 1324 (e.g., software) embodying any one or more of the methodologies or functions described herein. The instructions 1324 may also reside, completely or at least partially, within the main memory 1304, within the processor 1302 (e.g., within the processor's cache memory), or both, during execution thereof by the machine 1300. Accordingly, the main memory 1304 and the processor 1302 may be considered as machine-readable media. The instructions 1324 may be transmitted or received over a network 1326 (e.g., network 190) via the network interface device 1320.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1322 is shown in an example embodiment to be a single medium, the term “machine-readable medium” should be taken to include a single medium or multiple media (e.g., a centralized or distributed database, or associated caches and servers) able to store instructions (e.g., instructions 1324). The term “machine-readable medium” shall also be taken to include any medium that is capable of storing instructions (e.g., software) for execution by the machine, such that the instructions, when executed by one or more processors of the machine (e.g., processor 1302), cause the machine to perform any one or more of the methodologies described herein. The term “machine-readable medium” shall accordingly be taken to include, but not be limited to, a data repository in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing a pre-process workflow document including a plurality of document portions, the pre-process workflow document being configured to store data pertinent to a workflow;
accessing a tactical goal data structure representative of a tactical goal pertinent to the workflow, the tactical goal data structure corresponding to a task data structure that models a business process pertinent to the workflow;
accessing business process data resultant from the business process pertinent to the workflow;
modifying a document portion of the plurality of document portions based on the task data structure and based on the business process data; and
generating a post-process workflow document based on the pre-process workflow document and based on the modified document portion, the generating of the post-process workflow document being performed by a processor of a machine.

2. The method of claim 1, wherein:
the data is pertinent to at least one of the tactical goal data structure, the tactical goal, the task data structure, or the business process; and
the document portion is configured to store the data.

3. The method of claim 1 further comprising:
receiving at least one of the plurality of document portions; and
generating the pre-process workflow document from the plurality of document portions.

4. The method of claim 3, wherein:
a first document portion of the plurality of document portions is generated by a first machine configured to process first data that corresponds to at least one of the tactical goal data structure, the tactical goal, the task data structure, or the business process; and
a second document portion of the plurality of document portions is received from a second machine configured to process second data that corresponds to at least one of a further tactical goal data structure, a further tactical goal, a further task data structure, or a further business process.

5. The method of claim 4 further comprising:
communicating the post-process workflow document from the first machine to the second machine.

6. The method of claim 1 further comprising:
receiving user input that includes at least one of the tactical goal data structure, the tactical goal, the task data structure, or the business process; and
generating a business goal data structure inclusive of the tactical goal data structure based on the user input; wherein
the accessing of the tactical goal data structure includes accessing the business goal data structure.

7. The method of claim 1 further comprising:
accessing a database record that specifies at least one of the tactical goal data structure or the task data structure, the database record being stored in a database; and
generating a business goal data structure inclusive of the tactical goal data structure based on the database record; wherein
the accessing of the tactical goal data structure includes accessing the business goal data structure.

8. The method of claim 7 further comprising:
identifying the database record within the database.

9. The method of claim 8, further comprising:
initiating a query of the database based on a semantic annotation; wherein the identifying of the database record is based on the semantic annotation.

10. The method of claim 1, wherein:
the pre-process workflow document is stateless with respect to the workflow and stored in a file system devoid of metadata of the pre-process workflow document, the metadata being indicative of a document status with respect to the workflow.

11. The method of claim 1, wherein:
the business process data indicates a completion of the business process pertinent to the workflow; and
at least one of the modifying of the document portion or the generating of the post-process workflow document is responsive to the completion of the business process.

12. The method of claim 1 further comprising:
receiving the business process data via a user interface generated by a machine configured to process data pertinent to the workflow.

13. The method of claim 1 further comprising:
determining a task status of the business process pertinent to the workflow, the task status being indicative of whether the business process is successfully executed and whether the business process is executable.

14. The method of claim 13 further comprising:
determining an execution status of the workflow, the execution status including the task status of the business process.

15. The method of claim 1 further comprising:
determining an execution status of the workflow, the execution status including ordinal information of the task data structure, the ordinal information indicating whether the business process is executable prior to a further business process pertinent to the workflow.

16. A system comprising:
an access module configured to:
access a pre-process workflow document including a plurality of document portions, the pre-process workflow document being configured to store data pertinent to a workflow;
access a tactical goal data structure representative of a tactical goal pertinent to the workflow, the tactical goal data structure corresponding to a task data structure that models a business process pertinent to the workflow; and
access business process data resultant from the business process pertinent to the workflow; and
a hardware-implemented document module communicatively coupled to the access module and configured to:
modify a document portion of the plurality of document portions based on the task data structure and based on the business process data; and
generate a post-process workflow document based on the pre-process workflow document and based on the modified document portion.

17. The system of claim 16 further comprising:
a processing module configured to:
receive at least one of the plurality of document portions; and
generate the pre-process workflow document from the plurality of document portions; and wherein
a first document portion of the plurality of document portions is generated by a first machine configured to process first data that corresponds to at least one of the tactical goal data structure, the tactical goal, the task data structure, or the business process; and
a second document portion of the plurality of document portions is received from a second machine configured to process second data that corresponds to at least one of a further tactical goal data structure, a further tactical goal, a further task data structure, or a further business process.

18. The system of claim 16 further comprising:
a user module configured to receive user input that includes at least one of the tactical goal data structure, the tactical goal, the task data structure, or the business process; and
a business module configured to generate a business goal data structure inclusive of the tactical goal data structure based on the user input; and wherein
the access module is configured to access the tactical goal data structure by accessing the business goal data structure.

19. The system of claim 16 further comprising:
a user module configured to receive the business process data via a user interface presented to a user by a machine that is configured to process data pertinent to the workflow.

20. A machine-readable storage medium comprising instructions that, when executed by one or more processors of a machine, cause the machine to perform a method comprising:
accessing a pre-process workflow document including a plurality of document portions, the pre-process workflow document being configured to store data pertinent to a workflow;
accessing a tactical goal data structure representative of a tactical goal pertinent to the workflow, the tactical goal data structure corresponding to a task data structure that models a business process pertinent to the workflow;
accessing business process data resultant from the business process pertinent to the workflow;
modifying a document portion of the plurality of document portions based on the task data structure and based on the business process data; and
generating a post-process workflow document based on the pre-process workflow document and based on the modified document portion.
